(19) United States
(12) Patent Application Publication
(10) Pub. No.: US 2004/0012258 A1
(43) Pub. Date: Jan. 22, 2004

(54) Brake control apparatus with solenoid valve

(76) Inventors: Noriyuki Hosoi, Kariya-city (JP); Masanobu Yamaguchi, Okazaki-city (JP); Masayoshi Ohishi, Anjo-city (JP)

Correspondence Address: POSZ & BETHARDS, PLC, 11250 ROGER BACON DRIVE, SUITE 10, RESTON, VA, 20190, US

(21) Appl. No.: 10/405,034

(22) Filed: Apr. 2, 2003

(30) Foreign Application Priority Data
Apr. 3, 2002 (JP) 2002-101489

(51) Int. Cl. B60T 8/36

(52) U.S. Cl. 303/119.2

(57) ABSTRACT

In a brake control apparatus according to the present invention, a range of change in a hydraulic pressure with respect to an amount of current applied by a drive signal from a control circuit of an N/O valve provided in a hydraulic path that extends from a hydraulic pressure generation source to a wheel cylinder is set to be smaller than a range of change in a hydraulic pressure with respect to an amount of current applied to an N/C valve provided in a hydraulic path that extends from the wheel cylinder to a reservoir. Accordingly, it is possible to decrease the hydraulic pressure which is generated when the amount of current is minutely varied in the N/O valve, thereby enhancing controllability of the hydraulic pressure. This enables highly accurate hydraulic control.

### INCORPORATION BY REFERENCE

This application is based upon and claims the benefit of Japanese Patent Application No. 2002-101489 filed on Apr. 3, 2002, the contents of which are incorporated herein by reference.

### FIELD OF THE INVENTION

The present invention relates to a brake control apparatus in which solenoid valves adjust hydraulic pressure for generating braking force.

### RELATED ART OF THE INVENTION

Conventionally, some types of brake control apparatuses have controlled hydraulic brake pressure by varying a duty ratio of a pulse that switches the solenoid valve ON and OFF, when hydraulic pressure is supplied to and drained from each wheel cylinder by a solenoid valve in order to control vehicular braking force. In such hydraulic control apparatuses, a large pressure pulsation, i.e., pulse pressure, is generated in the hydraulic conduit by the repetition of switching, and the resulting vibration is transmitted to the driver through the vehicle body and/or the brake pedal. This causes a problem since the driver feels discomfort due to the vibration.

In order to prevent generation of the pressure pulsation, an art for linearly controlling an amount of current applied to a solenoid valve is disclosed (in Japanese Patent No. 3035999). In the related art, because hydraulic pressure is controlled by driving the solenoid valve by a linear output from a drive circuit, is effectively suppressed the generation of the pressure pulsation in the braking hydraulic piping while controlling the braking force.

Meanwhile, when linearly controlling a solenoid valve, if a computer-controlled digital control circuit is used for the drive circuit of the solenoid valve, an output from the drive circuit is not a complete linear output but a stepped output with a minute variation range inherent to each computer. Accordingly, it is not possible to set electromagnetic force of the solenoid valve generated by the drive current (or a pressure difference generated by resistance to the electromagnetic force) or a valve lift, i.e., it is not possible for the generated hydraulic pressure to set an variation range smaller than the minute variation range. Such a problem related to resolving power of a drive signal also exists in an analog circuit as well as in the digital circuit. Thus, there is scope for improvement in the related art described above.

### SUMMARY OF THE INVENTION

It is therefore an object of the present invention to provide a brake system that is capable of obviating the above problems.

It is therefore an object of the present invention to improve controllability of the hydraulic pressure responding to a drive signal, when linearly controlling a solenoid valve which is used in a brake control apparatus.

According to a first aspect of the present invention, a number of turns of a coil of the normally open solenoid valve is substantially the same as a number of turns of a coil of the normally closed solenoid valve.

In conventional cases, the number of turns of the coil of the normally open solenoid valve provided in the hydraulic path that extends from the hydraulic pressure generation source to the wheel cylinder is larger than the number of turns of the coil of the normally closed solenoid valve provided in the hydraulic path that extends from the wheel cylinder to the reservoir. However, according to the first aspect, the number of turns of the coils of both solenoid valves is substantially the same. That is, the number of turns of the coil of the normally open solenoid valve is substantially decreased. Therefore, a variation range of the hydraulic pressure generated in the normally open solenoid valve can be set smaller than a variation range in a drive signal (i.e. the first drive signal) for the normally open solenoid valve, thereby improving controllability of the hydraulic pressure.

In conventional cases, the sizes of the air gaps in the magnetic field of the normally open solenoid valve and the normally closed solenoid valve are the same. However, according to the second aspect, the size of the air gap of one of the two solenoid valves is larger than that of the other one. Therefore, a variation range of the hydraulic pressure generated in the solenoid valve with the larger air gap can be set smaller than a variation range in a drive signal, thereby improving controllability of the hydraulic pressure.

Accordingly, the amounts of current applied to the normally open solenoid valve and the normally closed solenoid valve are accurately controlled by the first and second drive signals, respectively. Therefore, electromagnetic force generated in each solenoid valve is accurately controlled, resulting in accurate control of the hydraulic pressure.

Further, according to a third aspect of the present invention, the control circuit has a resistor which is connected in series to at least one of signal paths of the first and second drive signals.

According to the third aspect, the variation range of the hydraulic pressure in the solenoid valve becomes smaller than the minimum variation range of the drive signal, and controllability of the hydraulic pressure is improved.

Conventionally, the electrical resistance of the normally open solenoid valve, i.e., the electrical resistance of the coil is larger than, and about twice as large as the that of the normally closed solenoid valve. However, according to the fourth aspect, the electrical resistance of the normally open solenoid valve is more than twice as large as that of the normally closed solenoid valve. Accordingly, controllability of the hydraulic pressure of the normally open solenoid valve is improved.

Accordingly, the amounts of current applied to the normally open solenoid valve and the normally closed solenoid valve are accurately controlled by the first and second drive signals. Therefore, electromagnetic force generated in each solenoid valve is accurately, thereby accurately controlling the hydraulic pressure.

### BRIEF DESCRIPTION OF THE DRAWINGS

Other objects, features and advantages of the present invention will be understood more fully from the following detailed description made with reference to the accompanying drawings. In the drawings:

FIG. 1 is a schematic view showing a configuration of a brake apparatus of a first embodiment of the present invention for a single wheel;

FIG. 2 is a cross sectional view showing an N/O valve as a normally open valve according to the first embodiment;

FIG. 3 is a line graph showing a relationship between the amount of current applied to a solenoid valve which is subject to linear control and the generated pressure difference according to the first embodiment;

FIG. 4 is a time chart showing an ABS control by the brake control apparatus of the first embodiment;

FIG. 5 is a line graph showing a relationship between a size of an air gap in a magnetic circuit and a generated hydraulic pressure in the solenoid valve according to a second embodiment of the present invention;

FIG. 6 is a circuit diagram showing a connection of the control circuit and the solenoid valve according to a third embodiment of the present invention; and

FIG. 7 is a time chart showing an ABS control of a brake control apparatus by a duty-controlled pulse driving of the related art invention.

### DETAILED DESCRIPTION OF THE PREFERRED EMBODIMENTS

The present invention will be described further with reference to various embodiments in the drawings.

<First Embodiment>

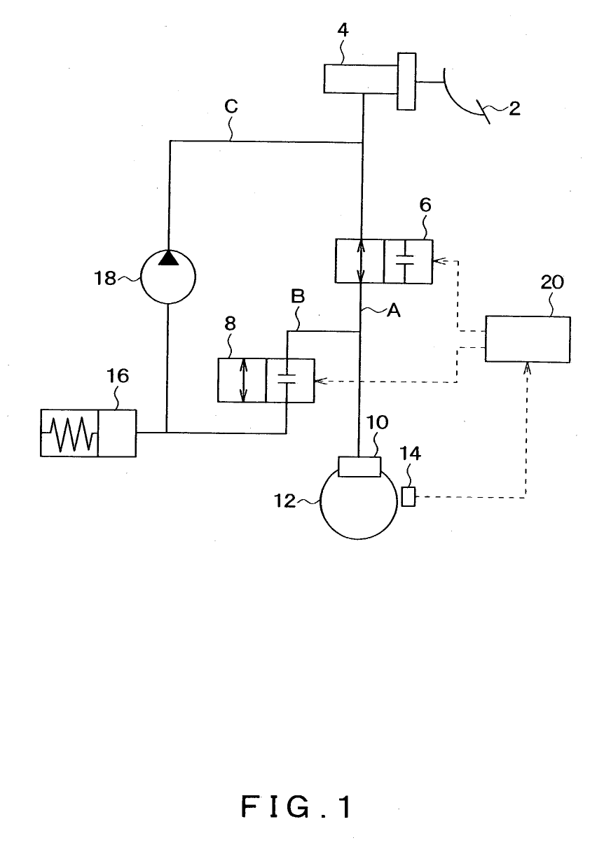

A first embodiment according to the present invention will be explained with reference to the drawings. FIG. 1 is a schematic view showing a brake control apparatus according to the first embodiment for a single wheel of a vehicle in which the apparatus is mounted.

As shown in FIG. 1, a master cylinder (M/C) 4 that generates hydraulic pressure in accordance with a depression amount of a brake pedal 2 is connected to a wheel cylinder (W/C) 10 that generates braking force on the wheel via a conduit A. The conduit A allows brake fluid to flow from a side of the M/C 4 to a side of the W/C 10, and is provided with a normally open solenoid valve 6 as a pressure increasing control valve. The normally open solenoid valve 6 acting as an N/O valve is in a communicated state before braking operation is performed, and controls a shut-off and non shut-off state of the conduit A in accordance with an amount of current applied thereto during an ABS control.

A conduit B is connected to a portion of the conduit A at the side of the W/C 10 (downstream side) of the normally open solenoid valve 6. The conduit B is provided with a normally closed solenoid valve 8 as a pressure reducing control valve for controlling a shut-off and non shut-off state of the conduit B. The normally closed solenoid valve 8 which acts as an N/C valve is in a shutoff state when the braking operation is normal state. However, at a period of pressure reduction during the ABS control, the N/C valve 8 is set to a shut-off state in accordance with an amount of current applied to the N/C valve 8, thereby releasing the brake fluid in the conduit A to the reservoir 16 so as to decrease a W/C pressure.

Moreover, a conduit C is connected to the conduit A the side of the M/C 4 (upstream side) closer than the normally open solenoid valve 6. The conduit C is provided with a pump 18 for sucking up and discharging the brake fluid that has been released to the reservoir 16 and returning it to the conduit A.

A wheel 12 is provided with a wheel speed sensor 14. Further, based on a detection signal from the wheel speed sensor 14, an ECU 20 that acts as a control circuit outputs the first and second drive signals for driving the normally open solenoid valve 6 and the normally closed solenoid valve 8, respectively, for executing the ABS control to be described later.

The normally open solenoid valve (hereafter referred to as “N/O valve”) 6 and the normally closed solenoid valve (hereafter referred to as “N/C valve”) 8 generate electromagnetic forces in accordance with the respective amounts of current of the first and second drive signals output from the ECU 20. Next, a hydraulic brake pressure is generated by pressure difference between the upstream and downstream from each valve that is generated based on the electromagnetic forces.

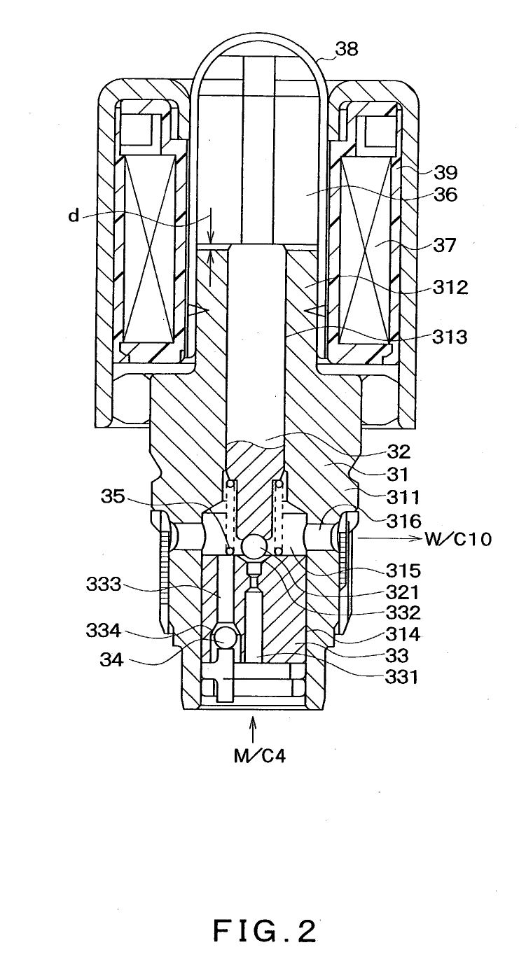

FIG. 2 is a cross sectional view of the N/O valve 6. Hereafter, only an essential portion of the N/O valve 6 will be explained. The N/O valve 6 is provided with a guide 31 which constitutes a magnetic member formed by a magnetic body. The guide 31 includes a guide hole 313 that is positioned at a small diameter portion 312 side and retains a shaft 32 slidably, a seat insertion hole 314 that is positioned at a side of a large diameter portion 311 and into which a seat 33 is press inserted, and a communication hole 316 for communicating a space 315 surrounded by a seat 33 and the seat insertion hole 314 with the conduit A connected to the W/C 10.

The shaft 32, which is cylindrical, is made of nonmagnetic metal (such as stainless steel) and one end thereof on a side of the seat 33 protrudes through the guide hole 313 of the guide 31 and extends to the space 315. A spherical valve body 321 is welded to the tip of the end of the shaft 32.

The shaft 32 is urged to a side of a plunger 36 by a spring 35 interposed between the shaft 32 and the seat 33, and the shaft 32 normally abuts against the plunger 36 so as to operate integrally therewith. Note that the shaft 32 and the plunger 36 corresponds to a movable member that moves in accordance with a balance between the M/C pressure and an electromagnetic force generated in accordance with the amount of current applied to a coil 37 to be described later.

An air gap d is formed between the guide 31 and the plunger 36 that integrally moves with the shaft 32 in order to prevent the plunger 36 and the guide 31 from being damaged by hitting each other during operation of the solenoid valve 6. Note that FIG. 2 shows the air gap d when the N/O valve 6 is not operated when the amount of current applied thereto is zero, that is, when the N/O valve 6 is in a communicated state.

A sleeve 38 is fitted in a peripheral side of the small diameter portion 312 of the guide 31. The sleeve 38 is made of non-magnetic metal (such as stainless steel), one end thereof is formed in an opened cup-like shape and a bottom face thereof is formed substantially spherical.

Further, the plunger 36, which is substantially cylindrical made of a magnetic body, is disposed on the bottom face of the sleeve 38 so as to be slidably movable in the sleeve 38. The plunger 36 is designed such that it touches the bottom face of the sleeve 38. When the plunger 36 touches the bottom face of the sleeve 38, the slidable movement of the plunger 36 in an upward direction shown in the figure is restricted. A spool 39 made of cylindrical resin, which houses the coil 37 forming the magnetic field when current is applied, is disposed around the sleeve 38.

A first communication path 331 is formed at a central portion in a radial direction of the cylindrical seat 33 for communicating the space 315 in the guide 31 with the conduit A. A tapered first valve seat 332, which a valve body 321 of the shaft 32 abuts against and separates from, is formed at an end portion on the side of the space 315 in the first communication path 331.

Moreover, a second communication path 333 for communicating the space 315 in the guide 31 with the conduit A is formed in parallel to the first communication path in the seat 33. A tapered second valve seat 334 which a spherical check valve 34 abuts against and separates from is formed at an end portion of the side of the conduit A in the second communication path 331.

The N/C valve 8 which acts as a normally closed electromagnetic valve has basically the same configuration as the N/O valve 6, except for in the following respect: a relationship between a direction in which the electromagnetic force is generated by the coil 37, a direction in which elastic force of the spring 35 is generated, and a direction upstream of the valve is such that the valve body 321 abuts against the first valve seat 332. In the case of the N/C valve 8, the relationship is opposite to that in the case of the N/O valve 6. Thus detailed explanation of the configuration of the N/C valve 8 will be omitted.

As described above, the coil 37 generates a magnetic field in the magnetic circuit constituted by the small diameter portion 312 of the guide 31, the air gap d, and the plunger 36 (which are connected in this order). The magnetic field generates electromagnetic attraction force F between the plunger 36 and the guide 31. As a result, the valve body 321 is driven in resistance to the elastic force of the spring 35 and abuts against the first valve seat 332.

At this time, when the M/C pressure is applied on the valve body 321 through the first communication path 331, a pressure difference as expressed by expression (1) is generated at the downstream side (i.e. the W/C 10 side) of the N/O valve 6, enabling braking force as the W/C pressure to be generated on the wheel 12.

Pressure difference=M/C pressure−W/C pressure (1)

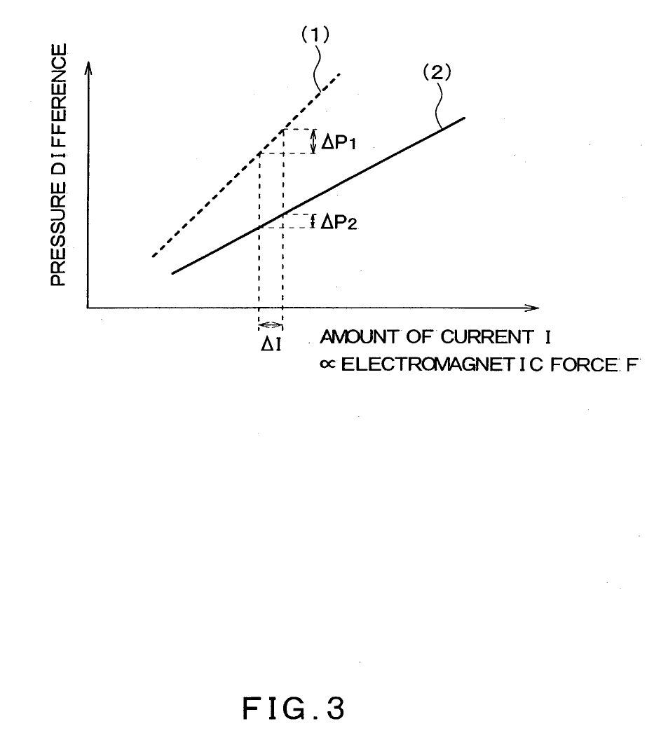

The relationship between the pressure difference and the amount of current will be described with reference to FIG. 3. The horizontal axis indicates an amount of current applied to the solenoid valve 6, and the vertical axis indicates the pressure difference I generated by the solenoid valve 6. As shown in expression (2), the electromagnetic force F (an attraction force or a repulsive force) generated by the solenoid valve 6 is proportional to the amount of current I as well as to a number of turns N of the coil 37 of the solenoid valve 6.

F=kNI (where k: proportionality constant) (2)

Therefore, the amount of current I (∝ electromagnetic force F) and the pressure difference has the following relationship: pressure difference=aI−b, or, pressure difference=cF−d (where a, b, c and d are constants). This relationship is expressed by a straight line as shown in FIG. 3. Note that the amount of current I is an exact current value in the case of linear driving. The amount of current I corresponds to an average current value in the case of pulse driving in which duty ratios are controlled.

Meanwhile, when the W/C pressure is to be precisely controlled to enhance performance of the ABS control, it is necessary to fine adjust the amount of current I. However, when the ECU 20 constituted by the computer is used for the drive circuit of the solenoid valve 6, a minimum variation range ΔI is generated due to a characteristic of the digital circuit. Therefore, the hydraulic pressure generated by the solenoid valve varies in a stepped manner just the same as the current that varies in a stepped manner for each ΔI. As shown in FIG. 3, when the gradient of the variation in the generated electromagnetic force is small (as indicated by line (2)) compared to the minimum variation range ΔI, rather than being large compared to the same minimum variation range ΔI (as indicated by line (1)), the variation range of the hydraulic pressure becomes smaller (ΔP1>ΔP2). Therefore, resolution of the hydraulic control is decreased and controllability thereof is enhanced.

The reduction of the variation range ΔP of the hydraulic pressure is achieved by reducing the electromagnetic force generated with respect to the amount of current I.

Therefore, in the brake control apparatus according to the first embodiment, the number of turns N of the coil 37 of the N/O valve 6 as a normally open electromagnetic valve is decreased. Specifically, a number of turns N1 of the coil of the N/O valve 6 is set equal to a number of turns N2 of the N/C valve 8.

Because the N/O valve 6 is normally operated longer than the N/C valve 8 during the ABS control, the N/O valve 6 is designed such that calorific power caused by current application is decreased while a necessary electromagnetic force (i.e. pressure difference) is generated. This design requires the numbers of turns to be N1>N2 such that the necessary electromagnetic force is generated with a small amount of current. On the contrary, in the present embodiment, in order to enhance controllability of the hydraulic pressure, the number of turns N1 of the N/O valve 6 is decreased smaller than that of in the above mentioned conventional cases and equal to that of the N/C valve 8. Accordingly, as shown by the line (2) in FIG. 3, the electromagnetic force with respect to the minimum variation range of the current ΔI is decreased, thereby enhancing the controllability of the hydraulic brake pressure when the N/O valve 6 is used.

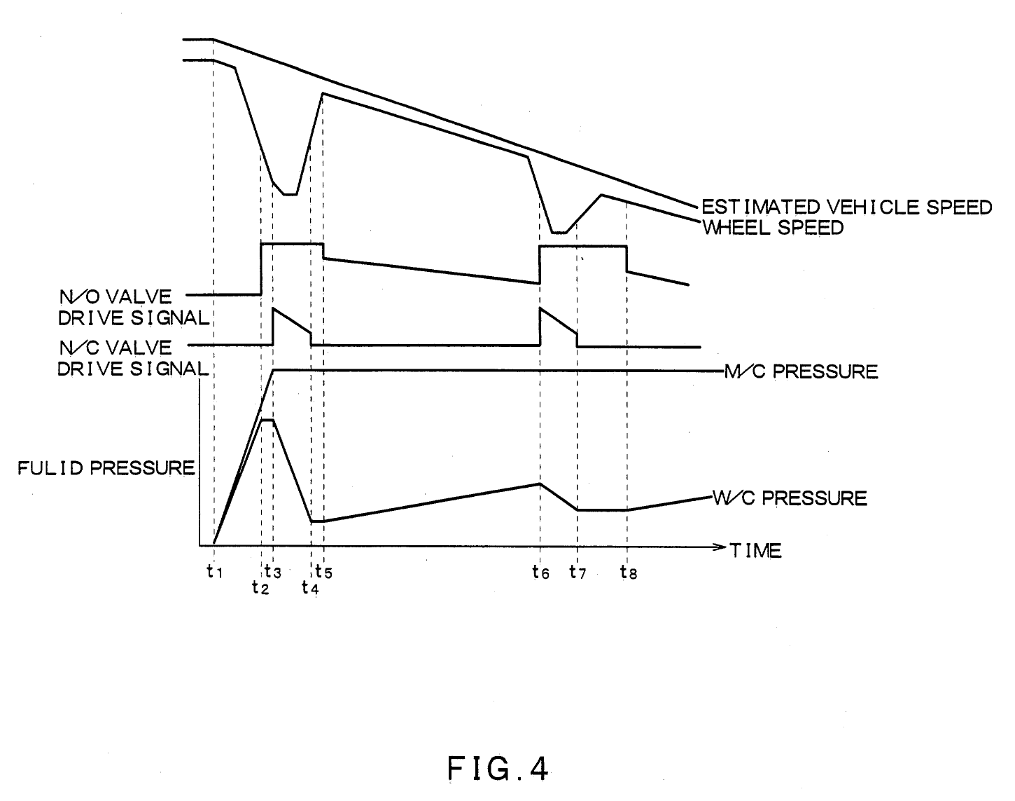

FIG. 4 shows a timing chart of the ABS control by the brake control apparatus according to the first embodiment, in which the N/O valve 6 and the N/C valve 8 are driven by linearlly controlled current which is output from the constant current circuit which serves as the control circuit in the ECU 20. Thus, the amount of current applied to each solenoid valve is equal to the output current value from the constant current circuit. Note that, the vertical axis of each time line indicates a relative value in FIG. 4. In this figure, an estimated vehicle speed is computed as a ground speed of the vehicle by the ECU 20, using estimation based on the detection signal of the wheel speed sensor 14 and the other signals.

When the brake pedal 2 is depressed at a time point t1, the M/C pressure is increased, and the W/C pressure is also increased accordingly. As a result, the wheel speed and the vehicle speed are decreased. The following explanation is based on the assumption that the brake pedal 2 is in a depressed state. The wheels tend to slippage so that the wheel speed becomes smaller than the vehicle speed and the ABS control starts at a time point t2. Therefore, the N/O valve 6 is shut off, and the W/C pressure is increased and maintained until a time point t3. At the time point t3, when the N/C valve 8 is opened, the W/C pressure is decreased since fluid is released from the conduit B to the reservoir 16. While a term between the time point t3 and a time point t4, in order to decrease the W/C pressure relatively and gradually, the amount of current applied to the N/C valve 8 is decreased in accordance with the elapsed time.

When the vehicle wheel speed begins to increase, that is, when the braking force is restored, at the time point t4, the amount of current applied to the N/C valve 8 is set to 0 (i.e. the N/C valve 8 is shut-off) so as to stop decrease of the W/C pressure (i.e. to maintain the W/C pressure). At a time point t5, the W/C pressure starts to be increased. After the time point t5, the amount of current applied to the N/O valve 6 is gradually decreased such that the W/C pressure is gradually increased. Accordingly, a sudden increase of brake force is not generated.

Continuously, when the wheel speed becomes smaller than the vehicle speed, the W/C pressure starts to be decreased again at a time point t6 due to shutting off of the N/O valve 6 and communication of the N/C valve 8. After the braking force is restored, decrease of the W/C pressure is stopped (i.e. the W/C pressure is maintained) at a time point t7. Next, the pressure is started once again. The ABS control is executed by repeating increase, decrease and maintenance of the W/C pressure until the vehicle is stopped.

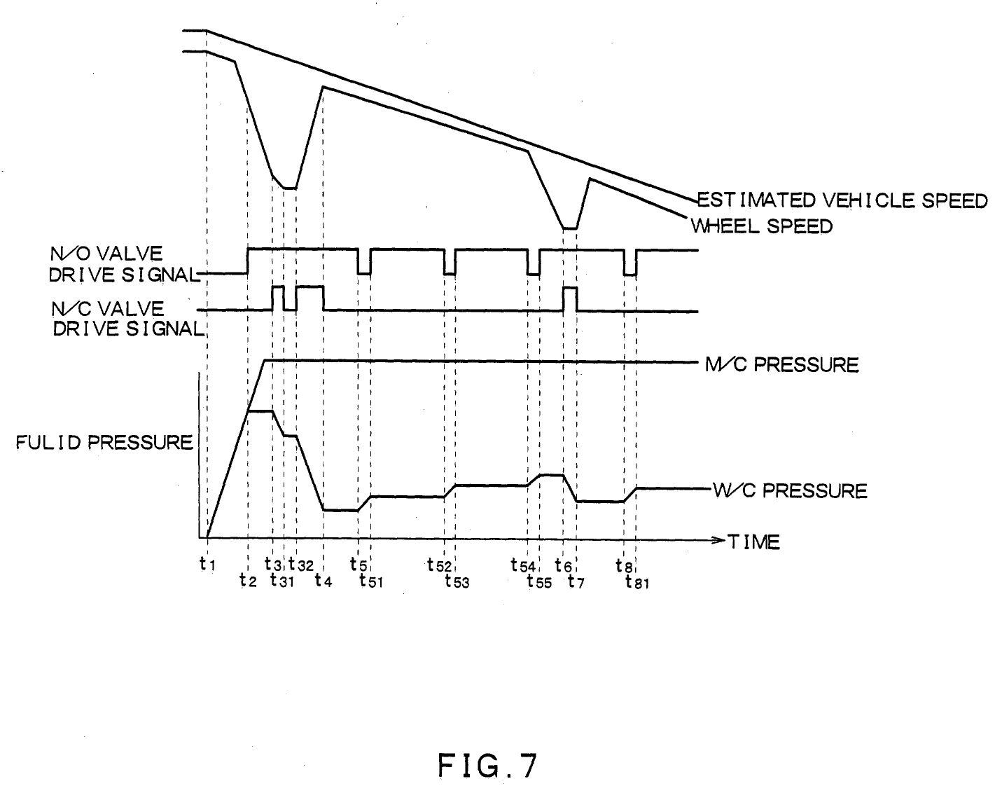

For the purpose of comparison, a typical procedure of a conventional ABS control using duty-ratio-controlled pulse driving will now be described with reference to a time chart illustrated in FIG. 7. The hydraulic conduit illustrated in FIG. 1 is used for the conventional ABS control. However, the drive signal output from the ECU 20 is a duty-ratio-controlled pulse signal that differs from the first embodiment.

When the brake pedal 2 is depressed at a time point t1, this increases the M/C pressure, and the W/C pressure increases accordingly. The wheel speed and the vehicle speed are decreased. The following explanation is based on the assumption that the brake pedal 2 is in a depressed state. The wheels tend to slippage so that the wheel speed becomes smaller than the vehicle speed and the ABS control starts at the time point t2. Therefore, the N/O valve 6 is shut off, and the W/C pressure is increased and maintained until a time point t3. At the time point t3, when the N/C valve 8 is opened, the W/C pressure is decreased since fluid is released from the conduit B to the reservoir 16. While a term between the time point t3 and a time point t4, in order to decrease the W/C pressure relatively and gradually, the amount of current applied to the N/C valve 8 is decreased in accordance with the elapsed time.

While the term between the time point t3 and the time point t4, in order to decrease the W/C pressure, the N/C valve 8 is opened. However, the N/C valve 8 is once shut off from a time point t31 to a time point t32 not to decrease W/C pressure too much.

When the wheel speed is increased andl it is almost equal to the vehicle speed, the N/C valve 8 is shut off at the time point t4, and the W/C pressure is decreased and maintained in a state in which the N/O valve 6 is shut off. Thereafter, in order to increase the W/C pressure, the N/O valve 6 is opened for short periods (between time points t5 and t51, between time points t52 and t53, and between time points t54 and t55) in a pulse like manner.

Continuously, when the wheel speed is decreased considerably compared to the vehicle speed, at a time point E6, the N/C valve 8 is opened for a short period (between a time point t5 and a time point t51, between a time point t52 and a time point t53, and between a time point t54 and a time point t55) so that the W/C pressure is slightly decreased.

Then, the ABS control is executed in the same manner as for the aforementioned time points from t4 to t7 by repeating communication of the N/O valve 6 for a short period and communication of the N/C valve 8 for a short period until the vehicle stops. That is, in this repetition, the W/C pressure is increased and increased pressure is then maintained by communication of the N/O valve 6 for a short period, and the W/C pressure is then decreased by communication of the N/C valve 8 for a short period.

As described above, in a conventional ABS control using pulse driving, the N/O valve 6 is constantly driven ON and OFF in an intermittent manner to increase the W/C pressure, while the N/C valve 8 is, though only during a short period, also intermittently driven ON and OFF to decrease the W/C pressure as shown in FIG. 7. Therefore, it is apparent that pressure pulsation is occasionally generated at the time of pulse driving.

The present embodiment realizes a smooth pressure change, as shown in FIG. 4, by linear control of the increase and decrease of the W/C pressure. Accordingly, no pressure pulsation is generated in the conduit and thus the driver feels no discomfort. Particularly, because the number of turns of the coil of the N/O valve 6, which is a normally open valve acting as a pressure increasing control valve, almost equals to that of the N/O valve 8, the gradient of the generated magnetic force with respect to the amount of current is made small. Consequently, resolution of the hydraulic control of the N/O valve 6 is enhanced. Therefore, in the present embodiment, even when the N/O valve 6 is driven by the ECU 20 acting as a digital circuit, the influence of the stepped change inherent to the digital output can be decreased.

It should be noted that, the above explanation addressed a case in which the N/O valve 6 and the N/C valve 8 are linearlly controlled. However, the present invention is not limited to this. In other words, it is possible for the N/O valve 6 to be linearlly controlled, and the N/C valve 8 to be driven by the conventional duty-ratio-controlled pulse drive signal. As illustrated in FIG. 4, during the execution of ABS control, the N/O valve 6 continuously repeats shutting off (100% current application), gradual opening (decrease in the amount of current), and shutting off. On the contrary, while the N/C valve 8 only executes opening (0% current application), shutting off, and opening (in this order) for a part of the period of shutting off the N/O valve 6. This means that the operation time of the N/O vale 8 is shorter than the N/O valve 6. Moreover, as shown in FIG. 1, a distance between the brake pedal 2 and the N/O valve 6 of the fluid passage is shorter than that between the brake pedal 2 and the N/O valve 8, and the N/C valve 8 is operated only when the N/O valve 6 is being shut off. As described above, vibration accompanying the operation of the N/C valve 8 (i.e. the generated pressure pulsation) cannot easily be transmitted to the brake pedal 2 by the N/O valve 6 which is being shut off.

Accordingly, the linear control for the N/O valve 6 exerts a greater effect on preventing of pressure pulsation than the N/C valve 8. Therefore, if the N/O valve 6 is structured to have a high resolution in the hydraulic control, and is linearlly controlled, it is possible to decrease the pressure pulsation accompanying the operation of the solenoid valve during the ABS control and prevent the pressure pulsation from being felt by the driver.

<Second Embodiment>

Next, a second embodiment will be described with reference to the drawings. The second embodiment aims to enhance the controllability of the hydraulic pressure by reducing the gradient of the generated electromagnetic force of the N/O valve 6 with respect to the amount of current. For this purpose, the air gap d between the plunger 36 and the guide 31 in the magnetic circuit of the solenoid valve is made larger as shown in FIG. 2.

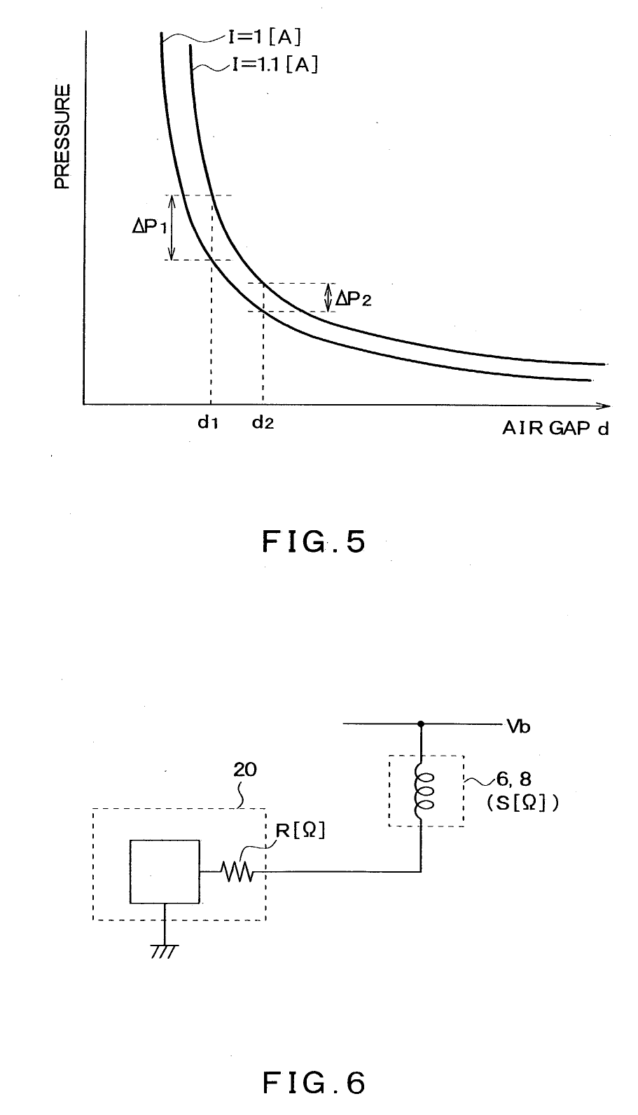

Namely, as shown in FIG. 5, there is a relationship between the pressure generated by the solenoid valve and the size of the air gap d where the pressure decreases as the air gap d increases. Two line diagrams in FIG. 5 indicate the characteristics when the amounts of current I are 1.0 (A) and 1.1 (A), respectively. The difference between the two amounts of current corresponds to the minute variation range in output ΔI (=0.1 A). Therefore, when the air gap is increased greatly from d1 to d2, the variation in pressure with respect to the minute variation range in output is decreased from ΔP1 to ΔP2. This indicates that, as with the relationship between the amount of current and the generated pressure difference as shown in lines (1), (2) in FIG. 3, when the size of the air gap is increased, controllability of the hydraulic pressure can be enhanced.

The second embodiment aims to enhance controllability of the hydraulic pressure of the N/O valve 6 by making the air gap d of the N/O valve 6 larger than the air gap of the N/C valve 8, though the air gap 5 of the N/O valve 6 is as the same size as that of the N/C valve 8 regarding the conventional cases. Other structure except the air gap of the N/O valve 6 is the same as that of the first embodiment, and the ABS control procedure is also the same.

<Third Embodiment>

A third embodiment of the present invention will be described with reference to the drawings. In the third embodiment, in order to enhance controllability of the hydraulic pressure by making the gradient of the magnetic force generated by the solenoid valve with respect to the amount of current smaller, the ECU 20 which acts as a control circuit outputs a drive signal of the N/O valve 6 (a first drive signal) from the constant voltage circuit. Moreover, the third embodiment aims to decrease the variation amount of the amount of current applied by the drive signal from the control circuit by providing interposing the resistance in series to the N/O valve 6 in the constant voltage circuit.

That is, as shown in FIG. 6, it is assumed that the ECU 20 drives the solenoid valve 6 or the solenoid valve 8 by the constant voltage circuit, and the constant voltage circuit is structured so as to have a resistance (Ω) in series to the solenoid valve. In this case, with respect to a battery voltage Vb (V) of a vehicle, a minimum variation range Δi2 (A) in the amount of current applied to the solenoid valve having a resistive component S (Ω) is expressed in expression (3). In the expression (3), n is a diversion number of the output and set to, for example, approx. 20.

Δi2=Vb/(S+R)/n (3)

On the contrary, when the constant voltage circuit does not have a series resistance R, the minimum variation range of the amount of current is as shown in expression (4).

Δi1=Vb/S/n (4)

Therefore, Δi2<Δi1. Thus, the minimum variation range of the amount of current applied by the constant voltage output from the control circuit constituted by a digital circuit may be decreased by interposing a series resistance in the constant voltage circuit.

In the third embodiment, the ECU 20 includes a series resistance R with a resistance value of 2 to 3 Ω. Accordingly, in the case where the resistance values of the N/C valve 8 and the N/O valve 6 are 4.3 Ω and 8.6 Ω, respectively, when the series resistance R is connected, the minimum variation range of the amount of current applied to the N/O valve 6 can be decreased from (Vb/n)/8.6 A to (Vb/n)/(10.6 to 11.6) A. Namely, the current value is decreased to a value between 0.81 and 0.74 times the current when the resistance value is 8.6 Ω.

The third embodiment has the same configuration as the first embodiment except that the ECU 20 which acts as the control circuit has the series resistance R, and the number of turns of the coil of the N/O valve 6 is larger than the number of turns of the coil of the N/O valve 8.

In the third embodiment, the load resistance to the constant voltage circuit which acts as a control circuit is increased from a conventional S (Ω) to S+R (Ω). Other than interposing the series resistance as above, various modifications are possible as below.

(a) The load resistance to the constant voltage circuit can be made substantially larger by making a coil diameter of the N/O valve 6 smaller, since the resistance of the coil wire increases by one divided by the square of the diameter. For example, in conventional cases the N/C valve 8 has a coil diameter of 0.27 mm and a resistance value of 4.3 Ω, and the N/O valve 6 has a coil diameter of 0.224 mm and a resistance valve of 8.6 Ω. In this modification, the coil diameter of the N/O valve 6 is changed to approx. 0.202 to 0.193 mm that corresponds to 0.75 to 0.71 times of the wire diameter of the coil of the N/C valve 8, without changing the number of turns of the coil of the N/O valve 6. Accordingly, it is possible to increase the resistance value to twice or more than that of the N/C valve 6, and more specifically, to approx. 2.46 times (10.6 Ω) to 2.69 times (11.6 Ω) that of the N/C valve 6. This arrangement corresponds to the setting of the series resistance value R at 2 to 3 Ω in the third embodiment.

As can be seen from the above, it is possible to increase the load resistance to the N/O valve 6 to 2.81 to 2.15 times that of the load resistance to the N/C valve 8, by setting the coil diameter of the N/O valve 6 which serves as a normally open valve to 0.7 to 0.8 times of the coil diameter of the N/C valve 8. Accordingly, the minimum variation range of the amount of current applied to the N/O valve 6 is made smaller and the N/O valve is linearlly controlled by the constant voltage circuit. Therefore, controllability of the hydraulic pressure is enhanced particularly when pressure is increased.

(b) A wire of the coil with high resistively may be adopted for the N/O valve 6 as one method to increase the load resistance to the N/O valve 6. If a coil having a resistively equivalent to 1.08 to 1.41 times that of a conventional coil is used for the N/O valve 6, a similar resistance is obtained as in the case of (a). In this case, the resistance value of the N/O valve 6 can be set to one 2.15 to 2.81 times of the resistance value of the coil for the N/C valve 8. Therefore, as in the case of (a) above, the minimum variation range of the amount of current applied to the N/O valve 6 is made smaller and the N/O valve 6 is linearlly controlled by the constant voltage circuit. Therefore, controllability of the hydraulic pressure is enhanced particularly when pressure is increased.

While the above description is of the preferred embodiments of the present invention, it should be appreciated that the invention may be modified, altered, or varied without deviating from the scope and fair meaning of the following claims.

What is claimed is:

1. A brake control apparatus comprising:
a normally open solenoid valve provided in a hydraulic path that extends from a hydraulic pressure generation source to a wheel cylinder;
a normally closed solenoid valve provided in a hydraulic path that extends from the wheel cylinder to a reservoir; and
a control circuit that increases and decreases a hydraulic brake pressure applied to the wheel cylinder by outputting first and second drive signals that drive the normally open solenoid valve and the normally closed solenoid valve respectively, and by controlling an amount of current applied by the first and second drive signals, wherein
a number of turns of a coil of the normally open solenoid valve is substantially the same as a number of turns of a coil of the normally closed solenoid valve.

2. The brake control apparatus according to claim 1, wherein the control circuit has a constant-current source circuit which outputs the first and second drive signals.

3. A brake control apparatus comprising:
a normally open solenoid valve provided in a hydraulic path that extends from a hydraulic pressure generation source to a wheel cylinder;
a normally closed solenoid valve provided in a hydraulic path that extends from the wheel cylinder to a reservoir; and
a control circuit that increases and decreases a hydraulic brake pressure applied to the wheel cylinder by outputting first and second drive signals that drive the normally open solenoid valve and the normally closed solenoid valve respectively, and by controlling an amount of current applied by the first and second drive signals, wherein
each of the normally open solenoid valve and the normally closed solenoid valve have an air gap in a magnetic circuit, and the air gap in one of the normally open solenoid valve and the normally closed solenoid valve is larger than the air gap in the other solenoid valve.

4. The brake control apparatus according to claim 3, wherein the control circuit has a constant-current source circuit which outputs the first and second drive signals.

5. A brake control apparatus comprising:
a normally open solenoid valve provided in a hydraulic path that extends from a hydraulic pressure generation source to a wheel cylinder;
a normally closed solenoid valve provided in a hydraulic path that extends from the wheel cylinder to a reservoir; and
a control circuit that increases and decreases a hydraulic brake pressure applied to the wheel cylinder by outputting first and second drive signals that drive the normally open solenoid valve and the normally closed solenoid valve respectively, and by controlling an amount of current applied by the first and second drive signals, wherein
the control circuit has a resistor which is connected in series to one of a respective signal path of the first and second drive signals.

6. The brake control apparatus according to claim 5, wherein the control circuit has a constant voltage source circuit which outputs the first and second drive signals.

7. A brake control apparatus comprising:
a normally open solenoid valve provided in a hydraulic path that extends from a hydraulic pressure generation source to a wheel cylinder;
a normally closed solenoid valve provided in a hydraulic path that extends from the wheel cylinder to a reservoir; and
a control circuit that increases and decreases a hydraulic brake pressure applied to the wheel cylinder by outputting first and second drive signals that drive the normally open solenoid valve and the normally closed solenoid valve respectively, and by controlling an amount of current applied by the first and second drive signals, wherein
an electrical resistance of the normally open solenoid valve is more than twice as large as that of the normally closed solenoid valve.

8. The brake control apparatus according to claim 7, wherein the control circuit has a constant voltage source circuit which outputs the first and second drive signals.
